(19) United States
(12) Patent Application Publication
(10) Pub. No.: US 2019/0299989 A1
(43) Pub. Date: Oct. 3, 2019

(54) PRIME MOVER POWER SHAPING CONTROLS RESPONSIVE TO SURROUNDING VEHICLE CHARACTERISTIC

(71) Applicant: Cummins Inc., Columbus, IN (US)

(72) Inventors: Pinak Jayant Tulpule, Columbus, IN (US); Vivek Anand Sujan, Columbus, IN (US)

(21) Appl. No.: 16/367,649

(22) Filed: Mar. 28, 2019

Related U.S. Application Data
(60) Provisional application No. 62/650,449, filed on Mar. 30, 2018.

(51) Int. Cl. B60W 30/16

(52) U.S. Cl. CPC B60W 30/16; B60W 2530/10; B60W 2550/14; B60W 2750/308; B60W 2550/308

(57) ABSTRACT

Apparatuses, methods and systems providing coordinated control of vehicle cohorts are disclosed. One embodiment is a method of controlling operation of a vehicle cohort including at least a rearward vehicle and a forward vehicle traveling in proximity to one another. The method includes determining a first vehicle desired motion based upon the second vehicle transient response capability and look-ahead route information, determining whether the first vehicle can achieve the first vehicle desired motion based upon a current vehicle separation, a first vehicle transient response capability, and the look-ahead route information, if no, determining whether the first vehicle can achieve the first vehicle desired motion with one or both of a modified vehicle separation and a modified first vehicle transient response capability, and, if yes, controlling operation of the first vehicle using the one or both of the modified vehicle separation and the modified first vehicle transient response capability.

### CROSS-REFERENCE TO RELATED APPLICATION

This application claims the benefit of and priority to U.S. Application No. 62/650,449 filed Mar. 30, 2018, which is hereby incorporated by reference.

### GOVERNMENT RIGHTS

This invention was made with government support under DE-AR0000793 awarded by Advanced Research Projects Agency-Energy (ARPA-E). The government has certain rights in the invention.

### BACKGROUND

The present disclosure relates to controls for shaping or modifying prime mover power or performance which are responsive to characteristics of surrounding vehicles. A group of vehicles may travel in close proximity using radar, lidar, proximity sensor information and may also coordinate among themselves using some form of direct or indirect (e.g., cloud-based) communication between vehicles. These techniques allow a group of two or more vehicles to accelerate or brake simultaneously and to maintain a particular distance around each other. They may also allow coordinated decisions among the vehicles for safety and optimized fuel economy and emissions. Employing these techniques as a group of vehicles travels over hilly terrain poses significant challenges. For example, hilly terrain compounds the difficulty in maintaining safe travel distance and minimizing or mitigating fuel consumption. Each vehicle has its own hill climbing and descending capabilities due to factors such as mass, transmission, final drive, engine torque rating and vehicle dynamics, among others. Different hill climbing capability results in changes in following distance on up hills and down hills. It has been proposed to address these challenges using feedback controls or feedforward controls from one vehicle to another to regulate vehicle following distance. These proposals have met with limited success, however, and require a complex controller and reliable fast V2V and/or V2I communication. These proposals also encounter stability and missing data problems. There remains a significant need for the unique apparatuses, methods, systems, and techniques disclosed herein.

### DISCLOSURE OF ILLUSTRATIVE EMBODIMENTS

For the purposes of clearly, concisely and exactly describing illustrative embodiments of the present disclosure, the manner and process of making and using the same, and to enable the practice, making and use of the same, reference will now be made to certain illustrative embodiments, including those illustrated in the figures, and specific language will be used to describe the same. It shall nevertheless be understood that no limitation of the scope of the invention is thereby created and that the invention includes and protects such alterations, modifications, and further applications of the illustrative embodiments as would occur to one skilled in the art.

### SUMMARY OF THE DISCLOSURE

Illustrative embodiments include unique apparatuses, methods, and systems of prime mover power or performance shaping. Further embodiments, forms, objects, features, advantages, aspects, and benefits shall become apparent from the following description and drawings.

### BRIEF DESCRIPTION OF THE DRAWINGS

FIG. 1 is a schematic illustration of certain aspects of an illustrative vehicle cohort control system.

FIG. 2 is a schematic illustration of certain aspects of an illustrative vehicle cohort controller and its inputs and outputs.

FIGS. 3A and 3B illustrate a flow diagram depicting certain aspects of an illustrative vehicle cohort control process.

### DETAILED DESCRIPTION OF ILLUSTRATIVE EMBODIMENTS

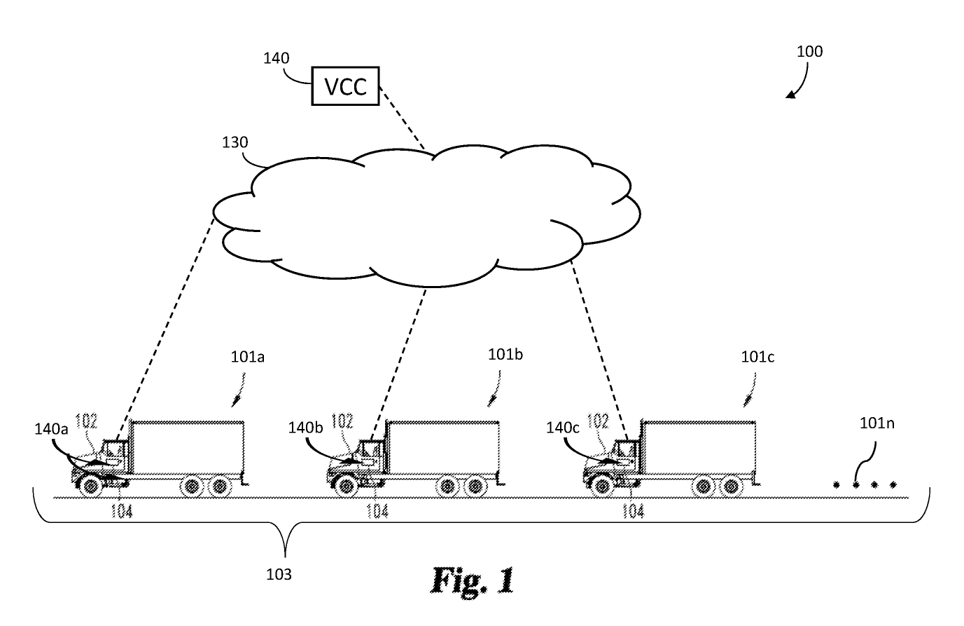

With reference to FIG. 1, there is illustrated a schematic view of an illustrative vehicle cohort control system 100 including a vehicle cohort 103 comprising a plurality of vehicles 101a, 101b, 101c and potentially additional vehicles as denoted by ellipsis 101n. Vehicles 101a, 101b, 101c, and other vehicles indicated be ellipsis 101n may be referred to individually as a vehicle 101 and collectively as vehicles 101 or collectively as vehicle cohort 103. While vehicle cohort 103 is illustrated as comprising at least three vehicles 101, it shall be appreciated vehicle cohorts according to the present disclosure may comprise any number of two or more vehicles traveling in proximity to one another such that information about characteristics, operation and/or performance of one or more of the vehicles can be obtained and processed to adjust or tune the power or performance characteristics of one or more of the vehicles in the cohort. Such processing may occur on-board one or more of the vehicles or at an off-board computing system in communication with one or more of the vehicles. It shall be further appreciated that certain forms of vehicle cohort operation may comprise platooning operation in which two or more vehicles actively participate in coordinating operation of the vehicle cohort. On the other hand, certain forms of vehicle cohort operation do not require the active participation of multiple vehicles. For example, one vehicle can sense or receive information about characteristics, operation and/or performance of one or more other vehicles in the cohort and process that information along with information about its own characteristics, operation and/or performance to adjust its own power or performance characteristics.

Vehicles 101 may be a variety of types of vehicles such as trucks, tractor-trailers, box trucks, buses, and passenger cars, among others. The vehicles 101 illustrated in FIG. 1 are depicted as tractor trailers, but other types of vehicle are contemplated herein. Some embodiments contemplate that vehicles 101 may each be the same or similar types of vehicles, for example, in the case of a commonly managed vehicle fleet. Some embodiments contemplate that vehicles 101 may comprise different types or classes of vehicles, for example, semi tractor-trailers and passenger cars. Each vehicle 101 includes a prime mover 102, such as an internal combustion engine or hybrid engine-electric system, structured to output power to propel the vehicle 101. Some embodiments contemplate that prime movers 102 may each be the same or similar types of prime movers, for example, in the case of a commonly managed vehicle fleet. Some embodiments contemplate that prime movers 102 may comprise different types or classes of prime movers, for example, prime movers of different sizes, powers or types (e.g., diesel engine powertrains, gasoline engine powertrains, natural gas powertrains, hybrid-electric powertrains, and electric powertrains). For ease of description prime mover 102 may be referred to herein as an engine, however, it shall be understood that these references also apply to and include other types of prime movers.

Vehicle cohort 103 is illustrated in a platooning mode of operation in which the vehicles act in a coordinated manner to reduce net fuel consumption and increase net operating efficiency of the vehicle cohort 103. Each vehicle 101 utilizes one or more environmental sensors to determine its positioning relative to other vehicles in vehicle cohort 103. Examples of the types of sensor systems that may be utilized include radar systems, lidar systems, proximity sensor systems, and combinations of these and/or other sensor systems. Each vehicle 101 in vehicle cohort 103 also includes a wireless communication system allowing vehicle-to-vehicle (V2V) communication or vehicle-to-X (V2X) communication where X denotes a variety of possible types of external networks including, for example, networks associated with stationary infrastructure assets.

Each vehicle 101 includes a vehicle electronic control system (VECS) 104 which is structured to control and monitor operation of its respective vehicle 101, as well as to participate in coordinated operation as disclosed herein. Each VECS 104 typically comprises one or more integrated circuit-based electronic control units (ECU) or other control components which may be operatively coupled to one another over a communication bus or network such as a controller area network (CAN) and which are structure to implement various controls, for example, an engine ECU structured to control and monitor operation of an engine and engine accessories, a transmission ECU structured to control and monitor operation of a transmission, a wireless communication ECU structured to control ex-vehicle wireless communications, and one or more environmental sensor ECUs structured to control operation of an environmental sensor system may be provided. It shall be appreciated that the control logic and control processes disclosed herein may be performed by controllers or controls which are implemented in dedicated control components of VECS 104 (e.g., in a dedicated ECU or other dedicated control circuity) or may be implemented in a distributed fashion across multiple control components of VECS (e.g., through coordinated operation of an engine ECU, a transmission ECU, a wireless communication ECU and an environmental sensor ECU).

The ECUs and other control components of VECS 104 may comprise of digital circuitry, analog circuitry, or hybrid combinations of both of these types. The ECUs and other control components of VECS 104 can be programmable, an integrated state machine, or a hybrid combination thereof. The ECUs and other control components of VECs 104 can include one or more Arithmetic Logic Units (ALUs), Central Processing Units (CPUs), memories, limiters, conditioners, filters, format converters, or the like which are not shown to preserve clarity. In one form, the VECS 104 is of a programmable variety that executes algorithms and processes data in accordance with operating logic that is defined by executable program instructions stored in a non-transitory memory medium (e.g., software or firmware). Alternatively or additionally, operating logic for the VECS 104 can be at least partially defined by hardwired logic or other hardware.

It shall be appreciated that electronic control systems and components thereof disclosed herein may be configured to determine or obtain a parameter, quantity, value or other operand based upon another parameter, quantity, value or other operand in a number of manners including, for example, by calculation, computation, estimation or approximation, look-up table operation, receiving a parameter, quantity, value or other operand from one or more other components or systems and storing such received parameter, quantity, value or other operand in a non-transitory memory medium associated with the electronic control systems or components thereof, other determination techniques or techniques of obtaining as would occur to one of skill in the art with the benefit of the present disclosure, or combinations thereof. Likewise the disclosed acts of determination or determining or obtaining a parameter, quantity, value or other operand based upon another parameter, quantity, value or other operand may comprise a number acts including, for example, acts of calculation, computation, estimation or approximation, look-up table operation, receiving a parameter, quantity, value or other operand from one or more other components or systems and storing such received parameter, quantity, value or other operand in a non-transitory memory medium associated with the electronic control systems or components thereof, other determination techniques or techniques of obtaining as would occur to one of skill in the art with the benefit of the present disclosure, or combinations thereof.

The environmental sensor and wireless communication capabilities of vehicles 101 allow their operation to be coordinated using direct or indirect communication. For example, vehicles 101 may accelerate or brake simultaneously, or in a coordinated sequence, maintain a particular distance relative to one another, or maintain a particular offset relative to one another. Coordinated operation also allows a closer following distance between vehicles by compensating for or eliminating reacting distance needed for human reaction. Coordinate operation of vehicle cohort 103 further allows for operation that reduces net fuel consumption or increases net efficiency of the vehicle cohort 103. One or more of the vehicles 101 may in some embodiments, be equipped with aerodynamic capability (wind assist panels on cab & trailer, aerodynamic tractor body) that creates a laminar flow of air (tunnel effect) that greatly reduces air drag. Other vehicles among vehicles 101 may be spaced close enough to the vehicle taking advantage of a wind break tunnel to increase fuel economy. It shall be appreciated that the controls disclosed herein can mitigate aerodynamic losses both by adjusting vehicle following distance(s) and vehicle offset.

Coordinated operation of vehicle cohort 103 may be provided at least in part by a vehicle cohort controller (VCC) 140. As illustrated in FIG. 1, VCC may be provided wholly or partially in a computing system remote from vehicle cohort, e.g., a cloud-based control system in operative communication with the VECS 104 of each of vehicles 101 via one or more communication networks 130. The VCC may also be provided, wholly or partially, on board one or more vehicles of a cohort and may be part of a VECS 104 or implemented in an independent electronic control system. For example, VCC 140a, 140b, 140c, the VCC may be provided in or in conjunction with the VECS 104 of one or more vehicles of cohort 103. In certain forms, the VCC may be distributed among two or more vehicles or two or more VECS 104 or other vehicle-based electronic control systems. Thus, it shall be appreciated that the VCC may be provided solely as VCC 140, solely as one of VCC 104a, 104b, 104c, as a distributed system including two or more of VCC 104a, 104b, 104c, or as a distributed system including VCC 140 and one or more of VCC 104a, 104b, 104c.

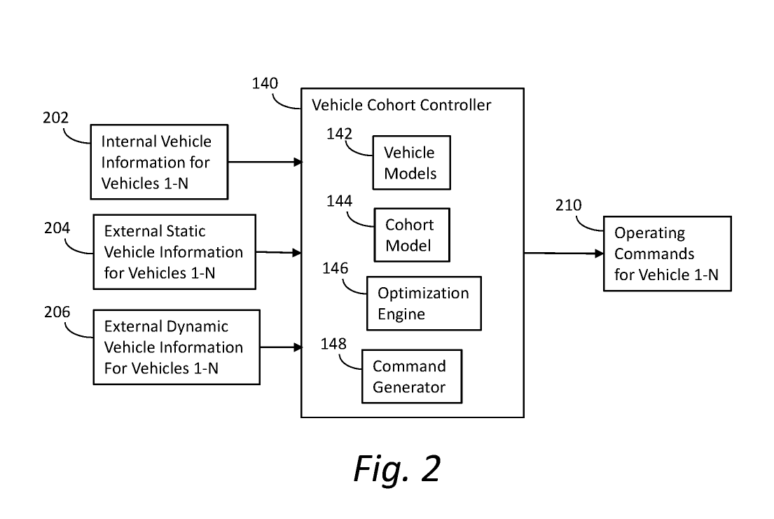

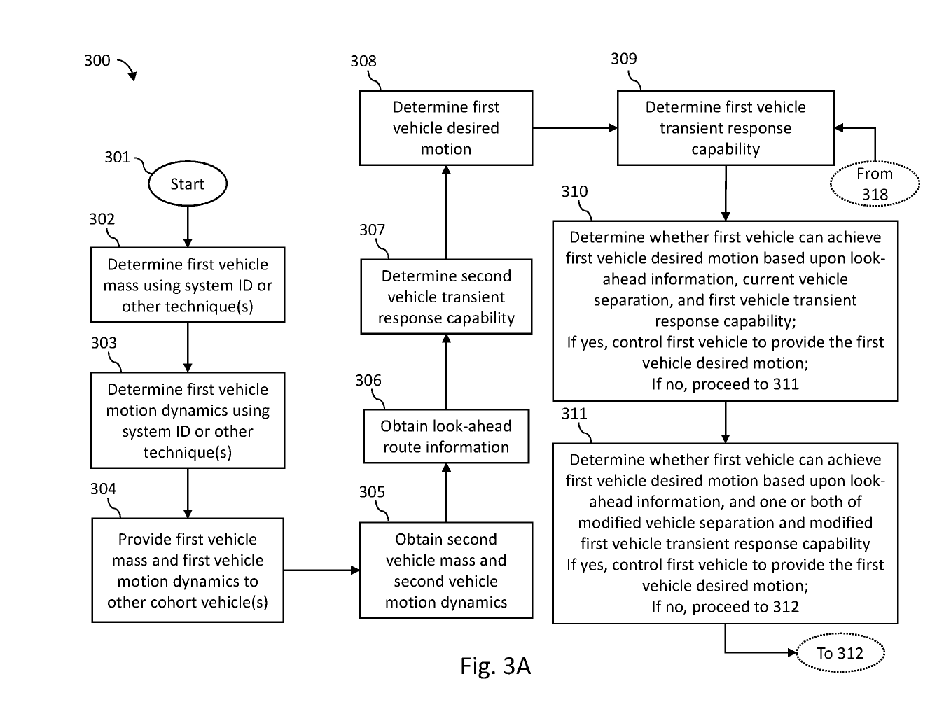

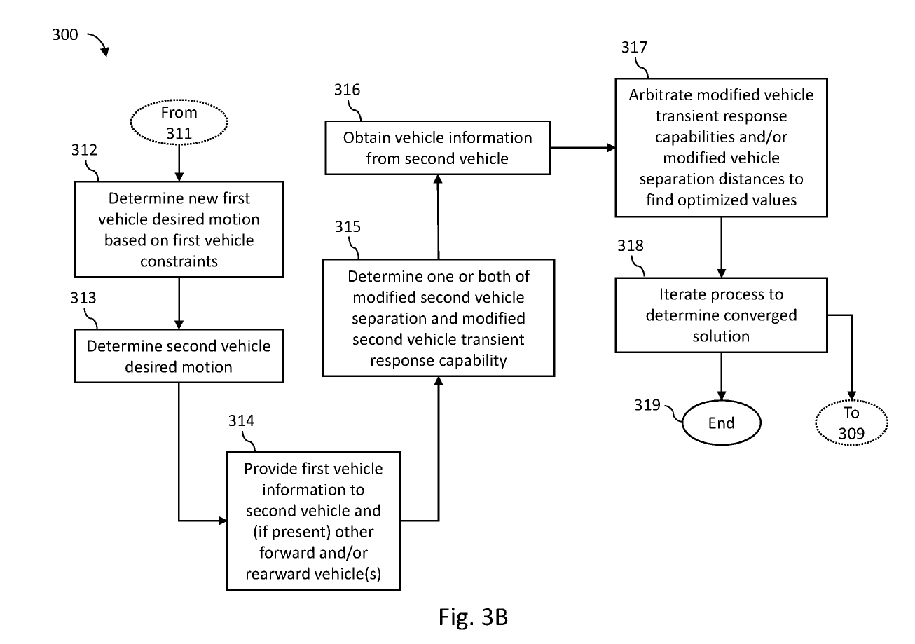

With reference to FIG. 2, there is illustrated a schematic depiction of one illustrative form of VCC 140. In the illustrated embodiment the VCC may perform a control process as illustrated in FIGS. 3A and 3B which includes prime mover power shaping based on vehicle platoons and surrounding vehicles. VCC 140 may determine a dynamic response capability change of either a forward or rearward vehicle (e.g., leading or following vehicle) so that a platoon formation may be maintained over undulating terrain and/or routes where speed is changing. VCC 140 may include block 142 vehicle models which may determine vehicle capability based on estimated and known vehicle parameters, block 144 cohort models which may determine vehicle cohort capability based on estimated and known cohort information, block 146 optimization engine which may tune vehicle performance based on both vehicle and cohort information, and block 148 command generator which may generate commands based on both vehicle and cohort information. VCC 140 may determine vehicle cohort operations including when to accelerate or brake simultaneously, or in a coordinated sequence to maintain a particular distance relative to one another, or maintain a particular offset relative to one another, which may reduce net fuel consumption or increases net efficiency of the vehicle cohort.

VCC 140 may be provided with inputs from block 202, 204 and 206. Block 202 provides internal vehicle information for vehicles 1-N (where 1 is a front vehicle and N is a number of rearward vehicles). Block 204 provides external static vehicle information for vehicles 1-N. Block 206 provides external dynamic vehicle information for vehicles 1-N. VCC 140 provides output block 210 which outputs operating commands to vehicles 1-N.

Internal vehicle information 202 may include information about vehicle components and immediate surrounding that changes with time and is available only at a given instance. This information may be available from on-board sensors and communication with other vehicle powertrain components, and may include, for example, engine speed, vehicle speed, temperature, humidity, and current road grade, among others. External static information 204 may include information about things outside of the vehicle that time-invariant or change over a longer time frame (e.g., hourly, daily, weekly or seasonally). This information may be available from map-based data via communication with other devices outside of the vehicle. This information may include, for example, road grade, intersections, curvature, charging locations, construction, etc.

External dynamic information 206 may include information about conditions outside of the vehicle that change frequently over time. This information may be available from V2V and/or V2X communication. This information may include, for example, traffic density, weather forecast, traffic light phases, road conditions, and fuel or electricity price, among others. Operating commands 210 for one or more of vehicles 1-N may include commands to adjust vehicle performance by, e.g., tuning the performance of the forward and/or rearward vehicles. To control a dynamic response capability of a vehicle cohort so that, e.g., the vehicle platoon formation may be maintained over undulating terrain and/or routes where speeds are changing. For example, VCC may process information about characteristics, operation and/or performance of one or more of the vehicles to adjust or tune the power or performance characteristics of one or more of the vehicles in the cohort. Such processing may occur on-board one or more of the vehicles or at an off-board computing system in communication with one or more of the vehicles. VCC 140 may automatically adjust safety system trims based on a variety of changing conditions. An important consideration for the deployment of an autonomous vehicle cohort is having a capable safety system. However, the capability of the safety system may need to be dynamically adjustable for a human operator to provide help when necessary.

With reference to FIGS. 3A and 3B there is illustrated a flow diagram of an illustrative control process 300 for controlling operation of at least one of a first vehicle and a second vehicle of a vehicle cohort wherein of the first vehicle and the second vehicle is rearward of the other. Process 300 may be implemented in connection with a number of vehicle cohorts including vehicle cohorts comprising a single forward vehicle and a single rearward vehicle, as well as vehicle cohorts including a greater number of vehicles in which case, there may be multiple forward vehicles and/or multiple rearward vehicles relative to a given vehicle in a cohort. As described below, process 300 may utilize parameters such as vehicle mass, vehicle losses such as power loss due to aerodynamic drag, power loss due to rolling resistance, and power loss due to powertrain losses. These parameters may be determined using system identification techniques such as vehicle parameter determination (VPD). Illustrative VPD techniques are disclosed in U.S. Pat. No. 10,000,214, entitled Vehicle Controls Including Dynamic Vehicle Parameter Determination and issued Jun. 19, 2018, the disclosure of which is hereby incorporated by reference.

The illustrative control process 300 may tune the vehicle performance of forward and rearward vehicles of a vehicle cohort based at least in part upon look-ahead route information and vehicle transient response capability information. Look-ahead route information may include road grade, traffic, weather, speed limit, and other information pertaining to the conditions over a look-ahead horizon for a vehicle cohort or a given vehicle in a vehicle cohort. Look-ahead route information may be determined by an electronic control system or component thereof in any of the manners of determining or determination disclosed herein.

Vehicle transient response capability information may include information indicative of a transient response capability of one or more forward vehicles of a vehicle cohort, e.g., acceleration capability and/or grade-climbing capability of a forward vehicle. Vehicle transient capability may additionally or alternatively include information indicative of a transient response capability of one or more rearward vehicles of a vehicle cohort, e.g., acceleration capability and/or grade-climbing capability of a rearward vehicle. A number of vehicle characteristics and route information may be used to determine vehicle capability information, e.g., engine torque curves or other limits imposed on engine torque or output, engine-wheel gear ratios, vehicle mass, vehicle losses such as aerodynamic, rolling, and powertrain losses, and road grade. Vehicle transient response capability information may be determined by an electronic control system or component thereof in any of the manners of determining or determination disclosed herein.

Vehicle transient response capability information or a forward vehicle and/or a rearward vehicle may be utilized in controlling vehicle cohort operation in a number of manners. For example, in case of a heavier forward vehicle, the performance of one or more rearward vehicles may be limited to match the performance capability of a forward vehicle. In case of a lighter forward vehicle, performance capability of one or more rearward vehicles may be enhanced to match the performance of the forward vehicle. At sufficiently closer distances aerodynamic losses may have a significant impact on a rearward vehicle due to its position relative to a forward vehicle. Vehicle performance may be tuned by dynamically changing engine torque curve limits and acceleration limits. A number of torque control or limiting features and/or acceleration control or limiting features may be modified to achieve desired platooning operation using dynamic control methods to achieve torque/power limiting. Dynamically modifying the vehicle separation may also be utilized to influence the aerodynamic loading of both the forward vehicle and the rearward vehicle thus impacting the aerodynamic drag coefficient (Cd) of both vehicles. Modifying the vehicle separation may include modifying vehicle separation distance or following distance, modifying vehicle lateral offset, modifying vehicle yaw, or combinations thereof. Additionally, modifying the vehicle separation may include such modification for a single vehicle of for multiple vehicles

Process 300 may be utilized in controlling a platoon comprising two or more vehicles participating in a common platooning process which may be subject to platoon-level control. Process 300 may additionally or alternatively be utilized in controlling a single vehicle attempting to draft off another vehicle without platoon-level control. Both scenarios shall be understood as examples of control over at least one vehicle of a vehicle cohort. Process 300 may modify the performance characteristics of a rearward vehicle to make optimal use of the forward vehicle.

Process 300 may include prime mover power shaping based on characteristics of surrounding vehicles. Process 300 may create a dynamic response capability to change either a forward or a rearward vehicle so that a platoon formation may be maintained over undulating terrain and/or routes where speeds are changing. The process may use information on estimated or known vehicle dynamics to determine the ability of a rearward vehicle to maintain, for example, a desired separation profile. When it is determined that a platoon is unable to maintain the requirements of a formation, then either a forward and/or a rearward vehicles capabilities may be adjusted so that the platoon can maintain formation. The control process 300 may make use of knowledge of the surrounding vehicles, the horizon data (both static and changing), telematics information, etc. to determine the best actuation strategy. The control process 300 may be applied to either a single vehicle operating independently, or a vehicle operating as part of a platoon.

The control process 300 may include critical safety systems and networks integrated into the vehicle system which may include safety system trims automatically adjusted based on a variety of dynamic operating and environmental conditions. An important consideration for the deployment of autonomous vehicles may be having a capable safety system in place. However, the capability of this safety system may need to be dynamically adjustable to seek help from a human operator when necessary.

With continuing reference to FIGS. 3A and 3B there is illustrated a flow diagram depicting certain aspects of illustrative control process 300 which may be performed by an electronic control system including one or more vehicle cohort controllers, such as one or more of VCC 140, 140a, 140b, and 140c. It shall be appreciated that a number of aspects and forms of process 300 may be performed by an electronic control system of a single vehicle of a vehicle cohort or by electronic control systems of multiple vehicles of a vehicle cohort. On the other hand, some aspects and forms of process 300 may require operation of electronic control systems of multiple vehicles of a vehicle cohort. For illustrative purposes, process 300 is described in terms of a first vehicle, which may be one of a forward vehicle and a rearward vehicle of a vehicle cohort, and a second vehicle which is the other of the forward vehicle and the rearward vehicle of the vehicle cohort. For example, the first vehicle described below may be a rearward vehicle of a vehicle cohort, and the second vehicle described below may be a forward vehicle which is forward of the rearward vehicle and which may be, although is not necessarily a lead vehicle. It shall be appreciated, however, that various aspects of process 300 may be instantiated in multiple control elements and may be in and performed by control elements of any number of vehicles of a vehicle cohort. For example, in certain forms, the electronic control systems of a plurality of vehicles in a vehicle cohort will each execute a control process according to process 300. It shall be further appreciated that the acts of determination and the acts of obtaining described in connection with process 300 may be performed by an electronic control system or component thereof in any of the manners of determining or determination disclosed herein.

Process 300 begins at start operation 301 and proceeds to operation 302 which determines a first vehicle mass. Different forms of operation 302 may use different techniques to determine the first vehicle mass. In certain forms, operation 302 may determine the first vehicle mass using one or more system identification (system ID) techniques which, in general terms, characterize parameters of a system by measuring inputs and outputs during a plurality of system conditions. In certain forms, the first vehicle mass may be determined using VPD techniques in accordance with the disclosure of U.S. Pat. No. 10,000,214 referenced herein above. In certain forms, the first vehicle mass may be a predetermined value. In certain forms, the first vehicle mass may be a calibratible value. In certain forms, the first vehicle mass may be determined using other techniques as would occur to one of skill in the art with the benefit of the present disclosure.

Process 300 proceeds from operation 302 to operation 303 which determines first vehicle motion dynamics. In general, first vehicle motion dynamics comprise information such as vehicle system loss information which may be utilized in combination with the first vehicle mass to determine a first vehicle transient response capability. Different forms of operation 303 may use different techniques to determine the first vehicle motion dynamics. In certain forms, operation 303 may determine the first vehicle motion dynamics using one or more system ID techniques. In certain forms, the first vehicle motion dynamics may be determined with information from sensors, or memory locations. The first vehicle motion dynamics may include terms accounting for one or more of aerodynamic losses, rolling resistance, powertrain losses, losses attributable to gravitational force and road grade and other vehicle losses. The first vehicle motion dynamics may include terms accounting for one or more of engine out power, power consumed to provide a desired acceleration. Such terms may be determined in accordance with the disclosure of U.S. Pat. No. 10,000,214 referenced herein above.

Process 300 proceeds from operation 303 to operation 304 which provides the first vehicle mass and the first vehicle motion dynamics to one or more other vehicles of a vehicle cohort. Operation 304 may communicate this information via an external wireless network, e.g., via a V2V network, a V2X network, or other types of wireless networks. The information communicated to cohort vehicles may also include other information. Certain forms of process 300 may omit operation 304. For example, in implementations the first vehicle receives information originating from one or more other vehicles of a vehicle cohort but does not communicate information to one or more other vehicles of the vehicle cohort may omit operation 304. Additionally, operation 304 may be omitted in one or more iterations of process 300 which the first vehicle does not communicate information to one or more other vehicles of the vehicle cohort while being performed in other iterations.

Process 300 proceeds from operation 304 to operation 305 which obtains a second vehicle mass and/or one or more second vehicle motion dynamics parameters pertaining to a second vehicle of the vehicle cohort. It shall be appreciated that operations and determinations described herein relative to a second vehicle, may also be performed for multiple other vehicles (i.e., two or more vehicles other than the first vehicle). Depending on the cohort position of the first vehicle, the one or more other vehicles may include one or more vehicles forward of the first vehicle and/or one or more vehicles rearward of the first vehicle. Operation 305 may obtain second (or other) vehicle mass and/or second (or other) vehicle motion dynamics parameters pertaining to one or more other vehicles via an external wireless network, e.g., via a V2V network, a V2X network, other types of wireless networks, or a combination thereof. In certain forms, operation 305 may obtain this information directly from one or more other vehicles of the vehicle cohort. In certain forms, operation 305 may obtain this information directly from one or more other network infrastructure assets, such as stationary network elements or assets. The obtained information may be originally wirelessly transmitted from an electronic control system of the one or more other vehicles. The obtained information may be determined, for example, in a manner corresponding to that described above in connection with the first vehicle mass and the first vehicle motion dynamics.

Process 300 proceeds from operation 305 to operation 306 which obtains look-ahead route information. In certain forms, the obtained look-ahead route information comprises road grade information. In certain forms the obtained look-ahead route information comprises additional and/or alternative vehicle motion constraint information such as information indicative of traffic, weather, speed limit or other regulatory limit information, geo-fencing and other information pertaining to the conditions over a look-ahead horizon for a vehicle cohort or a given vehicle in a vehicle cohort, such as those disclosed herein. Operation 306 may obtain look-ahead route information via on-vehicle determinations, via information received from one or more other vehicles of the vehicle cohort, via information received from one or more other network infrastructure assets, such as stationary network elements, or from combinations thereof. In certain forms, operation 306 may obtain look-ahead route information via an external wireless network, e.g., via a V2V network, a V2X network, other types of wireless networks, or a combination thereof.

Process 300 proceeds from operation 306 to operation 307 which determines a second vehicle transient response capability of another vehicle of the vehicle cohort, for example, a vehicle forward of the first vehicle or a vehicle rearward of the first vehicle. In certain forms, the second vehicle transient response capability may be determined based upon one or more of the vehicle mass, the vehicle motion dynamics, and the current velocity of the second vehicle. In certain forms, the second vehicle transient response capability may be determined by an electronic control system provided on-board the first vehicle based upon information obtained by the first vehicle such as the second vehicle mass and/or the second vehicle motion dynamics described above in connection with operation 305. In certain forms, the second vehicle transient response capability may be determined by an electronic control system provided on-board the second vehicle and communicated to the first vehicle. In certain forms, the second vehicle transient response capability may be determined by an electronic control system component of one or more other network infrastructure assets, such as stationary network elements, and communicated to the first vehicle. In certain forms, the second vehicle transient response capability may be determined by a combination of the foregoing techniques, for example, by an electronic control system distributed across two or more of the first vehicle, the second vehicle, and the other network infrastructure assets.

Process 300 proceeds from operation 307 to operation 308 which determines a first vehicle desired motion. The first vehicle desired motion may include information indicative of at least one of a desired acceleration and a desired velocity of the first vehicle. Vehicle desired motion in general, may include information indicative of at least one of a desired acceleration and a desired velocity of a given vehicle. The first vehicle desired motion, and vehicle desired motion in general, may additionally or alternatively include information indicative of coordinated acceleration or braking between two or more vehicles. The first vehicle desired motion, and vehicle desired motion in general, may additionally or alternatively include aspects of vehicle separation such as following distance, offset and yaw. Different forms of operation 308 may use different techniques to determine the first vehicle desired motion. In certain forms, operation 308 may determine the first vehicle desired motion based upon one or more of the second vehicle transient response capability, current velocity of the first vehicle, current velocity of the second vehicle, and the look-ahead route information. In certain forms, the first vehicle desired motion may be determined to provide at least one of an optimized efficiency and an optimized fuel economy of the first vehicle. For example, operation 308 may determine a desired acceleration and/or velocity of the first vehicle that improves efficiency and/or fuel economy by reducing aerodynamic drag, increasing downhill velocity in anticipation of an uphill grade, or other techniques as would occur to a person of skill in the art with the benefit of the present disclosure.

Process 300 proceeds from operation 308 to operation 309 which determines a first vehicle transient response capability. In certain forms, the first vehicle transient response capability may be determined based upon one or more of the first vehicle mass, the first vehicle motion dynamics, and the current velocity of the first vehicle. In certain forms, the first vehicle transient response capability may be determined using a constraint-based horizon. In certain forms, the first vehicle transient response capability may be determined by an electronic control system provided on-board the first vehicle. In certain forms, the second vehicle transient response capability may be determined by an electronic control system component of one or more other network infrastructure assets, such as stationary network elements or an electronic control system provided in part on-board another vehicle, and communicated to the first vehicle. In certain forms, the second vehicle transient response capability may be determined by a combination of the foregoing techniques, for example, by an electronic control system distributed across two or more of the first vehicle, the second vehicle, and the other network infrastructure assets.

Process 300 proceeds from operation 309 to operation 310 which determines whether the first vehicle can achieve the first vehicle desired motion. In certain forms, this determination may be based upon a current vehicle separation, the first vehicle transient response capability, and the look-ahead route grade information. In certain forms, this determination may utilize a prediction or simulation in which the first vehicle desired motion comprises at least part of a control target or objective, the first vehicle transient response capability comprises at least part of a vehicle operating constraint, the current vehicle separation comprises at least part of a vehicle aerodynamic loss constraint, and the look-ahead route information comprises at least part of a vehicle load constraint. If operation 310 determines that the first vehicle can achieve the first vehicle desired motion based upon look-ahead information, current vehicle separation, and first vehicle transient response capability, the first vehicle may be controlled to provide the first vehicle desired motion and process 300 may end or repeat. If operation 310 determines that the first vehicle cannot achieve the first vehicle desired motion based upon look-ahead information, current vehicle separation, and first vehicle transient response capability, process 300 proceeds to operation 311.

Operation 311 determines whether the first vehicle can achieve the first vehicle desired motion based upon the look-ahead information, and one or both of a modified vehicle separation a modified first vehicle transient response capability. The modified vehicle separation and the modified first vehicle transient response capability may be determined in a number of manners. In certain forms, the modified vehicle separation is evaluated first and the modified first vehicle transient response capability is evaluated second. In certain forms, the order of determination is reversed. In certain forms, the determinations occur at least in part concurrently or at least in part in parallel. In certain forms, the modified vehicle separation and the modified first vehicle transient response capability may be determined using a multi-variable optimization technique.

The modified vehicle separation may be determined to decrease aerodynamic losses in order to provide increased velocity or acceleration. This control scenario may occur, for example, in the case of a heavier vehicle following a lighter vehicle on an uphill grade as well as in other control scenarios as would occur to one of skill in the art with the benefit of the present disclosure. The modified vehicle separation may be determined to increase aerodynamic losses in order to provide decreased velocity or negative acceleration. This control scenario may occur, for example, in the case of a lighter vehicle following a heavier vehicle on a downhill grade as well as in other control scenarios as would occur to one of skill in the art with the benefit of the present disclosure. The modified vehicle separation may be determined relative to a forward vehicle (where present), and may also be determined relative to a rearward vehicle (where present). As with other aspects of process 300, the operation 311 may be configured to permit general implementation regardless of whether the first vehicle is a forward vehicle or a rearward vehicle. This may be accomplished, for example, by providing conditional logical operations accounting for both scenarios.

The modified first vehicle transient response capability may modify or tune one or more engine operating constraints, such as engine torque curve limits and acceleration limits, which may be increased to provide increased velocity or acceleration or to provide decreased velocity or negative acceleration as called for by different control scenarios. For example, engine torque limits may be increased for a following vehicle to provide the ability to achieve, or to more rapidly achieve, a modified vehicle following distance, engine torque limits may be decreased for a following vehicle to provide increased efficiency or decreased fuel consumption while still providing vehicle operation consistent with the capability of a forward vehicle.

If the first vehicle can achieve the first vehicle desired motion based upon look-ahead information, and one or both of the modified vehicle separation distance and the modified first vehicle transient response capability, operation 311 controls the first vehicle operation using the one or both of the modified vehicle separation and the modified first vehicle transient response capability. If, the first vehicle cannot achieve first vehicle desired motion based upon look-ahead information, and one or both of the modified vehicle separation distance and the modified first vehicle transient response capability, process 300 proceeds to operation 312.

Operation 312 determines a new first vehicle desired motion based on the constraints existing for the first vehicle. As noted above, for vehicle desired motion in general, the new first vehicle desired motion may include information indicative of at least one of a desired acceleration and a desired velocity of the first vehicle and may additionally or alternatively include information indicative of coordinated acceleration or braking between two or more vehicles, and/or aspects of vehicle separation such as following distance, offset and yaw. Different forms of operation 312 may use different techniques to determine the new first vehicle desired motion. In certain forms, operation 312 may determine the new first vehicle desired motion based upon one or more of the operands and considerations described above in connection with the first vehicle desired motion. In certain forms, the new first vehicle desired motion may provide a reduced benefit or a less-optimized result than the first vehicle desired motion described above. In certain forms, the new first vehicle desired motion may result in a reduced operational magnitude of the same type as the first vehicle desired motion, for example, a lesser magnitude of positive acceleration or braking.

Process 300 may proceed from operation 312 to operation 313 which determines a second vehicle desired motion. It shall be appreciated that certain forms of process 300 may omit one or more of operations 313 through 318. For example, in implementations the first vehicle receives information originating from one or more other vehicles of a vehicle cohort but does not communicate information to one or more other vehicles of the vehicle cohort may omit one or more of operations 313 through 318. Additionally, one or more of operations 313 through 318 may be omitted in one or more iterations of process 300 which the first vehicle does not communicate information to one or more other vehicles of the vehicle cohort while being performed in other iterations.

As noted above with respect to desired vehicle motion in general, the second vehicle desired motion determined by operation 313 may include information indicative of at least one of a desired acceleration and a desired velocity of the first vehicle, and may additionally or alternatively include information indicative of coordinated acceleration or braking between two or more vehicles, and/or aspects of vehicle separation such as following distance, offset and yaw. Different forms of operation 313 may use different techniques to determine the second vehicle desired motion. In certain forms, operation 313 may determine the second vehicle desired motion based upon the modified first vehicle transient response capability, current velocity of the first vehicle, current velocity of the second vehicle, and the look-ahead route information. In certain forms, the second vehicle desired motion may be determined to permit the first vehicle to achieve a desired vehicle separation and/or a desired first vehicle velocity. For example, the first vehicle may require greater or lesser velocity or acceleration of the second vehicle to achieve a desired vehicle separation. It shall be understood that this may or may not be possible, or desirable for the second vehicle. Accordingly, the second vehicle desired motion may be considered a request or optional command of the second vehicle.

Process 300 proceeds from operation 313 to operation 314 which provides first vehicle information to the second vehicle. Operation 314 may also communicate first vehicle information to other forward and/or rearward vehicle(s) if present in a given vehicle cohort. The information communicated in operation 314 may occur via a wireless network, e.g., via a V2V network, a V2X network, other types of wireless networks, or a combination thereof, and may be directly between vehicles or via intermediate network elements. The information communicated in operation 314 may include the second vehicle desired motion as well as additional information such as the first vehicle mass, the first vehicle motion dynamics, the first vehicle transient response capability, the modified first vehicle transient response capability, as well as other information.

Process 300 proceeds from operation 314 to operation 315 which determines one or both of modified second vehicle separation and modified second vehicle transient response capability. Operation 315 may make this determination in a manner which is the same as or similar to the determination described above in connection with operation 311 except that the modified second vehicle separation of operation 315 relates to the second vehicle and another vehicle of the cohort (if present) and the modified second vehicle transient response capability relates to the performance of the second vehicle.

Process 300 proceeds from operation 315 to operation 316 which obtains vehicle information from the second vehicle. Operation 315 may additionally or alternatively obtain vehicle information from other forward and/or rearward vehicle(s) if present in a given vehicle cohort. The information obtained in operation 316 may be communicated via a wireless network, e.g., via a V2V network, a V2X network, other types of wireless networks, or a combination thereof, and may be directly between vehicles or via intermediate network elements. The information obtained in operation 316 may include one or more of the types of information described above in connection with operation 314, except that such information would pertain to the second vehicle or to one or more other vehicles.

Process 300 proceeds from operation 316 to operation 317 which arbitrates modified vehicle transient response capabilities and modified vehicle separation distances to find optimized values. For example, the arbitration may be between the modified vehicle transient response capabilities and the second modified vehicle transient response capabilities, the modified vehicle separation and the second modified vehicle separation, or combinations thereof. The arbitration may utilize a multi-variable optimization technique to balance trade-offs to achieve a cohort-optimized set of control parameters. Operation 318 may be performed for or by a single vehicle, for example, in implementations or executions where the first vehicle does not communicate information to one or more other vehicles of the vehicle cohort. Operation 318 may also be performed for or by multiple vehicles, for example, in implementations or executions where the first vehicle does communicate information to one or more other vehicles of the vehicle cohort. In such instances, operation 318 may be performed in multiple instances relative to different vehicles in the cohort. In this manner, each vehicle can perform an appropriate arbitration without requiring further coordination, communication or feedback from other vehicles.

Process 300 proceeds from operation 317 to operation 318 which iterate process 300 to determine a converged solution. Operation 317 may determine the converged to provide a cohort-optimized set of control parameters or optimized control parameters for a single vehicle. The converging process may include iterating executions of process 300 in order to maintain a desired vehicle cohort formation over undulating terrain and/or routes where speeds are changing. From operation 318, process 300 may iterate by proceeding to operation 309 (or to another point in process 300 in some forms) or proceed to end operation 319, it being appreciated that process 300 may be later repeated.

It shall be appreciated that control process 300 may be used for active and autonomous safety systems for various types of vehicles and may include prime mover power shaping based on vehicle platoons and surrounding vehicles. In particular, the process may create a dynamic response capability change of either a forward or rearward vehicle so that, for example, a platoon formation may be maintained over undulating terrain and/or routes where speeds are changing. The process may use information on estimated or known vehicle dynamics to, e.g., determine the ability of rearward vehicles to maintain a desired separation distance. If it is determined that a vehicle platoon is unable to maintain the requirements of a formation, then either the capabilities of a forward and/or a rearward vehicle may be changed so that the platoon can maintain a formation. The process may use knowledge of surrounding vehicles, the horizon data (both static and changing), telematics information, etc. to determine the optimized motion for a vehicle platoon. The process may be equally applied to either a vehicle operating independently, where constraints associated with other vehicles are not considered, or a vehicle operating as part of a platoon, where constraints associated with other vehicles are considered.

While the operations of process 300 have been described above in one illustrative ordered sequence, process 300 may be implemented in a number of additional or alternative orders or sequences. As one basic example, operations 302 through 309 may be performed in a number of other orders or sequences, for example, the order of operations 302 and 303 may be reversed relative to the illustrated embodiment, or operations 302 and 303 may be performed in parallel or partially in parallel. A multiplicity of similar alternatives exists for the other operations of the illustrated embodiment provided that, for any given operation which requires information available only from one or more other operations, the given operation will be performed after the one or more other operations or sufficiently in parallel therewith such that the required information is available to the given operation. It shall be understood that recited or illustrated operations are otherwise not limited to a particular order unless expressly so stated. Thus, for example, operations 307 through 309 may be performed in any order or sequence including by parallel operation. It shall be further appreciated that speculative execution techniques may be utilized in certain microprocessor implementations of process 300 and may provide further ordinal flexibility and variation from the a priori order or sequence of the control logic being executed.

While illustrative embodiments of the disclosure have been illustrated and described in detail in the drawings and foregoing description, the same is to be considered as illustrative and not restrictive in character, it being understood that only certain illustrative embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of operating an electronic control system to control operation of at least one of a first vehicle and a second vehicle of a vehicle cohort with one of the first vehicle and the second vehicle being rearward of the other, the method comprising:
(a) determining a first vehicle transient response capability based upon a first vehicle mass and a first vehicle motion dynamics parameter;
(b) determining a second vehicle transient response capability based upon a second vehicle mass and a second vehicle motion dynamics parameter;
(c) determining a first vehicle desired motion based upon the second vehicle transient response capability and look-ahead route information;
(d) determining whether the first vehicle can achieve the first vehicle desired motion based upon a current vehicle separation, the first vehicle transient response capability, and the look-ahead route information;
(e) if the first vehicle cannot achieve the first vehicle desired motion based upon the first vehicle transient response capability and the look-ahead route information, determining whether the first vehicle can achieve the first vehicle desired motion with one or both of a modified vehicle separation and a modified first vehicle transient response capability; and
(f) if the first vehicle can achieve the first vehicle desired motion with the one or both of the modified vehicle separation and the modified first vehicle transient response capability, controlling operation of the first vehicle using the one or both of the modified vehicle separation and the modified first vehicle transient response capability.

2. The method of claim 1 wherein the first vehicle desired motion provides at least one of an optimized efficiency and an optimized fuel economy of the first vehicle.

3. The method of claim 1 wherein acts (a) through (f) are performed by an electronic control system on-board the first vehicle.

4. The method of claim 3 wherein the act of determining a first vehicle transient response comprises dynamically determining at least one of the first vehicle mass and the first vehicle motion dynamics parameter using one or more system identification techniques.

5. The method of claim 3 wherein the act of determining a second vehicle transient response capability comprises receiving via wireless communication originating from the second vehicle and storing in a non-transitory memory medium on-board the first vehicle at least one of: (i) the second vehicle transient response capability, and (ii) the second vehicle mass and the second vehicle motion dynamics parameter form which the second vehicle transient response capability can be determined on-board the first vehicle.

6. The method of claim 1 wherein communication between the second vehicle and the first vehicle includes the first vehicle receiving information originating from the second vehicle and does not include the second vehicle receiving information originating from the first vehicle.

7. The method of claim 1 comprising:
(g) determining a modified second vehicle transient response capability; and
(h) controlling operation of the second vehicle using the modified second vehicle transient response capability.

8. The method of claim 7 comprising:
(i) arbitrating between the modified first vehicle transient response capability and the modified second vehicle transient response capability to determine a one of a net optimized efficiency and a net optimized fuel economy of the first vehicle and the second vehicle.

9. The method of claim 7 comprising iterating at least acts (c) through (i) effective to determine a converged value for the one of the net optimized efficiency and the net optimized fuel economy of the second vehicle and the first vehicle.

10. The method of claim 1 wherein the act of controlling operation of the first vehicle using the transient response capability modification is effective to provide the first vehicle desired motion.

11. A system comprising:
an electronic control system including one or more integrated circuits and configured to control operation of at least one of a first vehicle and a second vehicle with one of the first vehicle and the second vehicle being rearward of the other, the electronic control system being configured to:
determine a first vehicle transient response capability based upon a first vehicle mass and a first vehicle motion dynamics parameter;
determine a second vehicle transient response capability based upon a second vehicle mass and a second vehicle motion dynamics parameter;
determine a first vehicle desired motion based upon the second vehicle transient response capability and look-ahead route information;
determine whether the first vehicle can achieve the first vehicle desired motion at a current vehicle separation based upon the first vehicle transient response capability and the look-ahead route information;
if the first vehicle cannot achieve the first vehicle desired motion based upon the first vehicle transient response capability and the look-ahead route information separation, determine whether the first vehicle can achieve the first vehicle desired motion with one or both of a modified vehicle separation and a modified first vehicle transient response capability; and
control operation of the first vehicle using one or both of the modified vehicle separation and the modified first vehicle transient response capability.

12. The system of claim 11 wherein the electronic control system is configured to determine the first vehicle desired motion to provide at least one of an optimized efficiency and an optimized fuel economy of the first vehicle.

13. The system of claim 12 wherein the electronic control system is contained on-board the first vehicle.

14. The system of claim 12 wherein the electronic control system is configured to:
determine a modified second vehicle transient response capability; and
control operation of the second vehicle using the modified second vehicle transient response capability.

15. The system of claim 14 wherein the electronic control system is configured to
arbitrate between the modified first vehicle transient response capability and the modified second vehicle transient response capability to determine a one of a net optimized efficiency and a net optimized fuel economy of the first vehicle and the second vehicle.

16. An apparatus provided as a component of an electronic control system configured to control operation of at least one of a first vehicle and a second vehicle with one of the first vehicle and the second vehicle being rearward of the other, the apparatus comprising:
a non-transitory memory medium configured with instructions executable by a controller to
determine a first vehicle transient response capability based upon a first vehicle mass and a first vehicle motion dynamics parameter;
determine a second vehicle transient response capability based upon a second vehicle mass and a second vehicle motion dynamics parameter;
determine a first vehicle desired motion based upon the second vehicle transient response capability and look-ahead route information;
determine whether the first vehicle can achieve the first vehicle desired motion based upon a current vehicle separation, the first vehicle transient response capability, and the look-ahead route information;
if the first vehicle cannot achieve the first vehicle desired motion based upon the current vehicle separation, the first vehicle transient response capability, and the look-ahead route information, determine whether the first vehicle can achieve the first vehicle desired motion with one or both of a modified vehicle separation and a modified first vehicle transient response capability; and
control operation of the first vehicle using one or both of the modified vehicle separation and the modified first vehicle transient response capability.

17. The apparatus of claim 16 wherein the first vehicle desired provides at least one of an optimized efficiency and an optimized fuel economy of the first vehicle.

18. The system of claim 17 wherein the non-transitory memory medium contained entirely on-board the first vehicle.

19. The system of claim 17 wherein the non-transitory memory medium is provided entirely in a single device.

20. The system of claim 17 wherein the non-transitory memory medium is distributed among a plurality of devices.
